(19) United States
(12) Patent Application Publication
(10) Pub. No.: US 2025/0355702 A1
(43) Pub. Date: Nov. 20, 2025

(54) ROUTING DIGITAL CONTENT ITEMS TO PRIORITY-BASED PROCESSING QUEUES ACCORDING TO PRIORITY CLASSIFICATIONS OF THE DIGITAL CONTENT ITEMS

(71) Applicant: OneTrust LLC, Atlanta, GA (US)

(72) Inventors: Shane Wiggins, Atlanta, GA (US); Kevin Jones, Atlanta, GA (US)

(21) Appl. No.: 18/866,865

(22) PCT Filed: May 17, 2023
(86) PCT No.: PCT/US2023/067138

§ 371 Date: Nov. 18, 2024

Related U.S. Application Data
(60) Provisional application No. 63/364,971, filed on May 19, 2022.

(51) Int. Cl. G06F 9/48; G06F 18/241

(52) U.S. Cl. CPC G06F 9/4881; G06F 18/241

(57) ABSTRACT

Methods, systems, and non-transitory computer readable storage media are disclosed for routing digital content items to priority-based processing queues based on classifications of the digital content items according to one or more system requirements frameworks. Specifically, the disclosed system scans and classifies digital content items at a digital data repository based on data types included in the digital content items. The disclosed system utilizes a classification model with a classification profile to classify the digital content items according to one or more system requirements frameworks and routes the digital content items to priority-based processing queues according to priority levels indicated by the classifications. Furthermore, the disclosed system provides indications of classifications of the portions of the digital content items (e.g., to indicate high priority data). The disclosed system can also perform additional computing operations on the digital content items according to the routing via the priority-based processing queues.

### CROSS-REFERENCE TO RELATED APPLICATIONS

This application claims priority to and the benefit of U.S. Provisional Patent Application No. 63/364,971, filed on May 19, 2022, which is incorporated herein by reference in its entirety.

### BACKGROUND

Advances in computer processing and data storage technologies have led to a significant increase in the amount and types of data moved to digital environments for processing. Specifically, many entities utilize computing devices to store, analyze, transmit, and/or perform a number of computing operations on different types of data. Computing systems handling (e.g., collecting, receiving, transmitting, storing, processing, sharing, and/or the like) certain types of digital data are often subject to handling such data in a compliant manner according to different regulations or frameworks. More specifically, many data processes for handling data are subject to various laws, regulations, and industry standards that include requirements for handling such types of data in specific ways (e.g., via certain computing processes, limitations, or capabilities) for security and privacy reasons.

Many entities provide or utilize services that involve many devices communicating over a network to make requests for performing various processes in connection with the services. For example, entities that provide services in connection with personal security, medical industries, network security, etc., often involve a large number of devices communicating with one or more server devices to send, receive, and process data via electronic requests (e.g., messages or other events) associated with the services. Handling many such requests from various computing systems-sometimes thousands or hundreds of thousands of requests-can require a significant amount of computer processing power and time utilizing a finite amount of processing power and/or processing bandwidth. Furthermore, when certain computing systems provide a significantly greater number of requests to an entity than other computing systems, processing the requests from the various computing systems in an efficient and timely manner can be a challenging process.

Due to different system requirements frameworks having different control requirements, implementing such controls in computing systems can be a challenging and time-sensitive task. In particular, many entities handle large amounts of data (e.g., petabytes) that are covered by various system requirements frameworks (e.g., personally identifiable information covered by various regulations or standards). The complexity and scale of processing such large amounts of data in one or more data processes can result in a significant amount of time and computing resources. More specifically, scanning and analyzing petabytes of data to identify data that corresponds to a system requirements framework (e.g., utilizing cloud-based systems) can often take many days.

Additionally, because certain types of data covered by specific system requirements frameworks have higher time sensitivity than other data types, processing large amounts of data over many days can result in higher-priority data being exposed to security risks (e.g., data breaches or other unauthorized access). Furthermore, as system requirements frameworks, computing systems, and data change over time, re-processing large amounts of data to address the changes in a timely manner is often unfeasible and can introduce additional technical challenges. Conventional systems typically leverage processes that fail to fairly and efficiently allocate computing resources for processing requests from different computing systems or of different data types due to the greatly varying needs of each computing system and limited computing resources.

### SUMMARY

This disclosure describes various aspects for routing digital content items to priority-based processing queues based on classifications of the digital content items according to one or more system requirements frameworks. For example, the disclosed systems execute operations to scan and classify a plurality of digital content items at a digital data repository based on data types included in the digital content items. The disclosed systems utilize a classification model with a classification profile to classify portions of data extracted from the digital content items according to one or more system requirements frameworks. The disclosed systems utilize the classifications to route the digital content items to priority-based processing queues according to priority levels indicated by the classifications of the portions of the digital content items. Furthermore, in some embodiments, the disclosed systems provide indications of classifications of the portions of the digital content items (e.g., to indicate high priority data). The disclosed systems can also perform additional computing operations on the digital content items according to the routing via the priority-based processing queues. The disclosed systems thus provide efficient prioritization and routing of data utilizing granular classification of portions of digital content items.

### BRIEF DESCRIPTION OF THE DRAWINGS

Various embodiments will be described and explained with additional specificity and detail through the use of the accompanying drawings.

FIG. 1 illustrates an example of a system environment in which a queue priority management system can operate in accordance with one or more embodiments.

FIG. 2 illustrates an example of an overview of the queue priority management system routing a plurality of digital content items to priority-based processing queues based on data classification in accordance with one or more embodiments.

FIG. 3 illustrates an example of the queue priority management system determining priority levels of digital content items in accordance with one or more embodiments.

FIG. 4 illustrates an example of the queue priority management system routing a digital content item to a priority-based processing queue based on classifications of portions of the digital content item in accordance with one or more embodiments.

FIG. 5 illustrates an example of the queue priority management system routing digital content items from an initial processing queue to a target processing queue via a plurality of priority-based processing queues in accordance with one or more embodiments.

FIG. 6 illustrates an example of the queue priority management system generating data payloads including information associated with digital content item prioritization for display via a client device in accordance with one or more embodiments.

FIG. 7 illustrates an example of a system architecture of the queue priority management system executing a digital content scanning request in accordance with one or more embodiments.

FIG. 8 illustrates an example of a graphical user interface for managing scanning requests of digital datasets with data prioritization based on one or more system requirements frameworks in accordance with one or more embodiments.

FIG. 9 illustrates another example of a graphical user interface for managing scanning requests of digital datasets with data prioritization based on one or more system requirements frameworks in accordance with one or more embodiments.

FIG. 10 illustrates another example of a graphical user interface for managing scanning requests of digital datasets with data prioritization based on one or more system requirements frameworks in accordance with one or more embodiments.

FIG. 11 illustrates a graphical user interface of a client device for setting a classification profile for an entity in accordance with one or more embodiments.

FIG. 12 illustrates an example flowchart of a process for routing digital content items via priority-based processing queues according to data classifications in accordance with one or more embodiments.

FIG. 13 illustrates an example of a computing device in accordance with one or more embodiments.

### DETAILED DESCRIPTION

This disclosure describes one or more embodiments of a queue priority management system that provides priority-based processing of data based on data classifications determined according to one or more system requirements frameworks. For example, the queue priority management system scans received data (e.g., in connection with one or more processing requests) to determine various attributes of the data. More specifically, the queue priority management system utilizes a classification model to determine data types within a plurality of digital content items in connection with the system requirements framework(s). Furthermore, the queue priority management system determines priority levels of the digital content items according to the classifications of the data types within the digital content items. The queue priority management system utilizes the priority levels of the digital content items to route (e.g., publish or partition) the digital content items to priority-based processing queues for performing one or more additional computing operations on the digital content items according to the corresponding priority levels. The queue priority management system can thus prioritize processing requests including sensitive data or corresponding to specific data types for processing more quickly in the priority-based processing queues (e.g., by processing highest priority digital content items first).

In one or more embodiments, the queue priority management system queue priority management system determines a classification profile associated with an entity. In particular, the queue priority management system determines the classification profile indicating priority levels for various data types and/or specific attributes of digital content items. For instance, the queue priority management system determines that specific types of data associated with the entity have various priority levels according to one or more system requirements frameworks.

According to one or more embodiments, the queue priority management system utilizes a classification model with the classification profile to classify digital content items in a digital data repository. Specifically, the queue priority management system extracts portions of each digital content item (e.g., phrases, terms, or other identifiable portions of data). Additionally, the queue priority management system utilizes the classification model to generate a classification of each extracted portion of a digital content item according to the classification profile.

In one or more additional embodiments, the queue priority management system utilizes the classifications to route the digital content items. In particular, the queue priority management system identifies a plurality of priority-based processing queues associated with various priority levels. The queue priority management system routes the digital content items to the priority-based processing queues according to the priority levels of the digital content items as determined by the classification profile. Thus, in some embodiments, the queue priority management system assigns high priority digital content items to a high priority processing queue, low priority digital content items to a low priority processing queue, etc.

In some embodiments, the queue priority management system performs additional computing operations on the digital content items utilizing the priority-based processing queues. For instance, the queue priority management system performs computing operations on digital content items (e.g., redacting, deleting, or encrypting information) based on the priority levels of the priority-based processing queues. Thus, the queue priority management system performs the computing operations on digital content items with higher priority levels prior to those with lower priority levels. Furthermore, the queue priority management system can continue scanning and routing digital content items to the priority-based processing queues while also performing computing operations on digital content items within the priority-based processing queues.

In one or more embodiments, the queue priority management system provides information indicating priority level information associated with digital content items. Specifically, the queue priority management system detects a set of one or more digital content items that have specific priority levels (e.g., at or above a threshold priority level) and generates, for each digital content item, a data payload corresponding to the digital content item. The queue priority management system can provide the data payloads including information associated with the digital content item(s) for display at a client device.

In one or more embodiments, the queue priority management system improves upon shortcomings of conventional systems in relation to managing computing systems that handle data according to various requirements of certain laws, regulations or standards. Specifically, conventional systems lack efficiency in ingesting digital data for performing various computing operations in connection with complying with various system requirements frameworks via implementing specific controls within computing environments. For example, some conventional systems typically utilize a single processing queue to process data from different sources and different data types, where the data types and/or the nature of the data source has no impact on the position in the processing queue of the data to be processed. By utilizing a single processing queue without regard for the content or context of data items, such conventional systems inefficiently process data that may be more time-sensitive or otherwise have a higher priority than other data. More specifically, when processing large amounts of data via a single processing queue from a number of different sources and including different data types over a long time period, the conventional systems can experience high latency and expose such data to security risks.

In some embodiments, the disclosed queue priority management system provides a number of advantages over conventional systems. For example, queue priority management system provides improved efficiency and flexibility of computing systems that process digital content items. In contrast to conventional systems that utilize a single processing queue to process data, the queue priority management system determines processing priorities for data based on sensitivity level and data type. In particular, the queue priority management system can scan and classify data to identify more important/urgent data from less important data for generating processing priority levels of digital content items. Additionally, by classifying digital content items based on various attributes (e.g., sensitive/confidential information corresponding to one or more system requirements frameworks) and/or access rights to the digital content items, the queue priority management system can improve data security by prioritizing the most important data over less important data, regardless of an original scanning order.

As an example, utilizing a single processing queue to process large amounts of data (e.g., petabytes of data), as in conventional systems, can result in significant processing wait time for processing highly sensitive/confidential data. In particular, scanning such large amounts of data can result in wait times of several days or weeks to process the data in the processing queue. Leaving highly sensitive data in such processing queues can introduce a significant amount of risk that highly sensitive data is exposed to malicious actors by, for example, failing to classify the data according to its sensitivity and to timely implement relevant controls at the processing devices or in repositories where the data resides. Accordingly, by automatically detecting sensitive information in digital content items and reordering the processing priorities into a plurality of sub-queues within the processing queue to ensure that the most sensitive information is processed first, the queue priority management system can reduce the security risks to the highly sensitive information.

More specifically, in contrast to conventional digital data processing systems, the queue priority management system performs an initial operation of classifying incoming data into a processing queue to determine how to route the data via a plurality of priority-based processing queues for more efficiently and quickly processing specific data types. For example, the queue priority management system can ensure that various controls associated with various system requirements frameworks are applied in a timely manner to digital content items covered by the system requirements frameworks (e.g., by automatically redacting, removing, or otherwise modifying high priority data or by performing data subject access requests). Thus, the queue priority management system can prevent high priority data from being exposed to data breaches or malicious actors as a result of delays in in a processing queue.

Furthermore, the queue priority management system can also provide improvements in processing smaller batches of data. Specifically, some processing operations can generate a significant amount of metadata for each digital content item. Accordingly, the queue priority management system can improve the efficiency by reducing the delay between initial processing operations and presenting information (e.g., notifications regarding sensitive information) or recommendations for correcting issues regarding digital content items that include sensitive information. In some cases, system requirements frameworks, such as frameworks governing data subject access requests, require entities to respond within a certain amount of time. Accordingly, increasing the processing speed of corresponding digital content items can reduce the risk of entities failing to comply with such regulatory frameworks. The queue priority management system can thus improve the efficiency and flexibility of computing systems that process various amounts of data while also complying with various requirements. Furthermore, the queue priority management system can also prioritize sensitive data for performing various additional computing operations while continuing to process a dataset including the sensitive data.

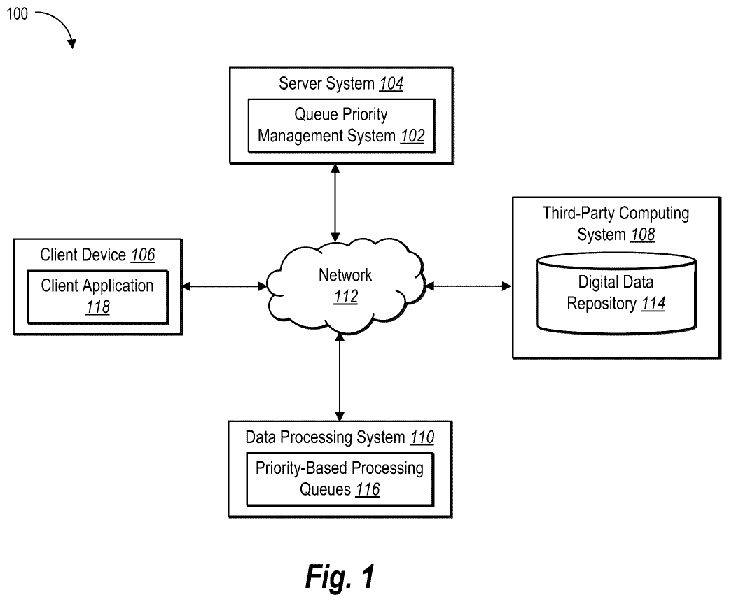

Turning now to the figures, FIG. 1 includes an embodiment of a system environment 100 in which an queue priority management system 102 is implemented. In particular, the system environment 100 includes a server system 104, a client device 106, a third-party computing system 108, and a data processing system 110 in communication via a network 112. Moreover, as shown, the third-party computing system 108 includes a digital data repository 114. FIG. 1 also shows that the client device 106 include client application 118, and the third-party computing system 108 includes a digital data repository 114.

As shown in FIG. 1, in one or more embodiments, the server system 104 can include or host the queue priority management system 102. Specifically, the queue priority management system 102 includes, or is part of, one or more systems that processes digital content items from the digital data repository 114 at the third-party computing system 108. For example, the queue priority management system 102 provides tools to the client device 106 for managing data associated with an entity. In one or more embodiments, the queue priority management system 102 provides tools to the client device 106 via the client application 118 for viewing and managing information associated with the entity and/or data that the entity handles (e.g., processes, transmits, stores).

As used herein, the term “digital content item” refers to a computer representation of data. For example, a digital content item includes, but is not limited to, text or images stored in a digital format such as a computer file. According to one or more embodiments, a digital content item includes a text document with one or more data tables with rows and columns of data associated with one or more topics. In some embodiments, a digital content item includes a form (e.g., a medical form) with fields corresponding to one or more topics. In further embodiments, a digital content item includes a digital record of a transaction (e.g., an electronic payment transaction) including data or metadata identifying details of the transaction. A digital content item can also include a portion of a computing application, such as an executable, a script, a dynamic link library, or other digital file.

In one or more embodiments, the queue priority management system 102 (or another system associated with the queue priority management system 102) provides tools for managing one or more computing devices and/or datasets in connection with a system requirements framework. As used herein, the term “system requirements framework” refers to an established set of requirements specified by a governing body such as a professional body, government, or other entity that enacts the set of requirements. To illustrate, a system requirements framework can include a set of regulations, standards, or laws that include, for example, a set of practices established by the International Organization for Standardization (“ISO”), internally by a particular organization (e.g., a multinational corporation), or a territory government (e.g., the European Union). In one or more embodiments, a system requirements framework includes a set of digital data management or control operations indicating requirements for handling specific types of data within a computing environment. Additionally, a system requirements framework can include requirements for establishing or managing computing operations and infrastructure that handle specific data types.

In one or more embodiments, the queue priority management system 102 provides tools to manage data in view of the system requirements framework via a digital representation of the system requirements framework. For instance, the queue priority management system 102 generates a data object (e.g., a digital object) for tracking and managing requirements and controls associated with the system requirements framework. Furthermore, the queue priority management system 102 can install controls associated with the system requirements framework by managing additional data objects representing digital content items or other data according to the digital representation of the system requirements framework within a computing environment.

As used herein, the term “control” refers to a tool or function for satisfying a requirement from a system requirements framework for a computing environment. An example of a control is a procedure or practice for handling specific data types that entities are required to follow in connection with a regulation governing security or privacy. For instance, a control can include requirements for handling personally identifiable information, financial information, medical information, legal information, or other data types. Furthermore, as used herein, the term “control action” refers to an action to install a particular control for handling specific data types. To illustrate, control actions can include actions for monitoring physical environments, installing environmental protections, restricting or reviewing access authorization to physical data centers, installing physical security controls, implementing specific security or privacy rules within an organization, etc.

Additionally, as used herein, the term “computing operation” refers to a computing process that performs one or more actions on specified data. In some embodiments, a computing operation includes modifying a digital content item or using the digital content item to modify one or more other digital content items. For example, the queue priority management system 102 utilizes a computing operation to copy a digital content item, delete a digital content item, or modify data within a digital content item. To illustrate, a computing operation can include modifying a digital content item to redact data in the digital content item or encrypt a digital content item (e.g., redacting or encrypting credit card information or personally identifiable information detected within a digital content item including a data table).

According to one or more embodiments, the queue priority management system 102 manages digital content items by communicating with the digital data repository 114 (e.g., via the third-party computing system 108) and/or the priority-based processing queues 116 (e.g., via the data processing system 110). Specifically, the queue priority management system 102 can communicate with the digital data repository 114 to determine or otherwise obtain information associated with the digital content items. Additionally, the queue priority management system 102 can communicate with the priority-based processing queues 116 to provide information associated with the digital content items in connection with processing the digital content items.

In some embodiments, the client device 106 controls or uses the third-party computing system 108 and/or the digital data repository 114 for the entity. The queue priority management system 102 may be configured to communicate with the digital data repository 114 on behalf of the entity via an integration that is installed on the third-party computing system 108 that is configured with the entity's credentials (e.g., via an integrated data extraction software application). The queue priority management system 102 can obtain metadata or other information about the digital content items (e.g., for one or more datasets including the digital content items).

In one or more aspects, the term “data extraction software application” refers to a computing application that operates on a computing device to extract data from the computing device or another computing device. For example, the machine-learning management system 102 includes a data extraction software application to access the digital data repository 114 utilizing credentials (e.g., login information, tokens) and extract (e.g., obtain) data including files, directories, or data within files. Additionally, in some aspects, the machine-learning management system 102 utilizes a data extraction software application to install one or more scripts, functions, or components of the data extraction software application at one or more other computing devices (e.g., the digital data repository 114 and/or the third-party computing system 108). Thus, the machine-learning management system 102 can integrate with the digital data repository 114 and/or the third-party computing system 108 via the data extraction software application.

The queue priority management system 102 can further communicate with the data processing system 110 to manage processing of digital content items from the digital data repository 114. For instance, the queue priority management system 102 can categorize the digital content items (e.g., by classifying the digital content items utilizing a classification model) and then route the digital content items to specific queues in the priority-based processing queues 116. Accordingly, the queue priority management system 102 can manage routing of data from the third-party computing system 108 to the data processing system 110 according to priority levels associated with the data.

Furthermore, the queue priority management system 102 can communicate with the client device 106 to obtain information associated with the digital content items or to provide information about the digital content items for display within the client application 118. For instance, the queue priority management system 102 can obtain, via user input received from the client device 106, metadata or other information about the digital content items and/or operations involving the digital content items, such as for a scanning request to identify high priority digital content items.

In one or more embodiments, the third-party computing system 108 includes server devices, individual client devices, or other computing devices associated with an entity. For instance, a third-party computing system includes one or more computing devices for performing one or more data processes involving handling data associated with one or more operations of the entity subject to a particular system requirements framework. To illustrate, the third-party computing system 108 includes one or more server devices that generate, process, store, or transmit payment card processing data subject to PCI DSS in one or more jurisdictions.

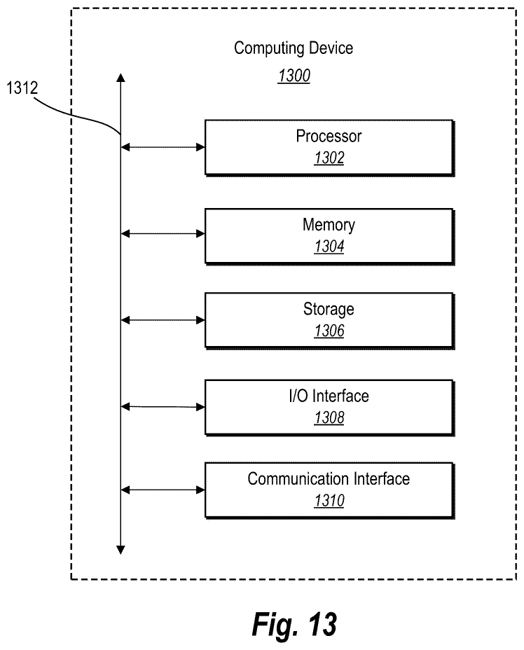

In one or more embodiments, the server system 104 includes a variety of computing devices, including those described below with reference to FIG. 13. For example, the server system 104 includes one or more servers for storing and processing data associated with one or more data processes. In some embodiments, the server system 104 can also include a plurality of computing devices in communication with each other, such as in a distributed storage environment. In some embodiments, the server system 104 include a content server. The server system 104 also optionally includes an application server, a communication server, a web-hosting server, a social networking server, a digital content campaign server, or a digital communication management server.

In one or more embodiments, the client device 106 includes, but is not limited to, a desktop, a mobile device (e.g., smartphone or tablet), or a laptop including those explained below with reference to FIG. 13. Furthermore, although not shown in FIG. 1, the client device 106 can be operated by users (e.g., a user included in, or associated with, the system environment 100) to perform a variety of functions. In particular, the client device 106 performs functions such as, but not limited to, accessing, viewing, and interacting with digital content items and/or data processes involving the digital content items in connection with one or more system requirements frameworks. In some embodiments, the client device 106 also perform functions for generating, capturing, or accessing data to provide to the queue priority management system 102 in connection with processing the digital content items. For example, the client device 106 communicates with the server system 104 via the network 112 to provide information (e.g., user interactions) associated with digital content items. Although FIG. 1 illustrates the system environment 100 with a single client device, in some embodiments, the system environment 100 includes a plurality of client devices. In some embodiments, the client device 106 or the server system 104 also host the digital data repository 114.

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server system 104, the client device 106, the digital data repository 114, and the third-party computing system 108 communicate via the network using one or more communication platforms and technologies suitable for transporting data and/or communication signals, including any known communication technologies, devices, media, and protocols supportive of data communications, examples of which are described with reference to FIG. 13.

Although FIG. 1 illustrates the server system 104, the client device 106, the third-party computing system 108, and the data processing system 110 communicating via the network 112, in alternative embodiments, the various components of the system environment 100 communicate and/or interact via other methods (e.g., the server system 104, the client device 106, the third-party computing system 108, and/or the data processing system 110 can communicate directly). Furthermore, although FIG. 1 illustrates the queue priority management system 102 and the data processing system 110 being implemented separately within the system environment 100, the queue priority management system 102 and the data processing system 110 can alternatively be implemented, in whole or in part, by a particular component and/or device within the system environment 100 (e.g., the server system 104). Additionally, in some embodiments, the third-party computing system 108 includes the client device 106.

In some embodiments, the queue priority management system 102 can be executed on a server system that provides a multi-tenant environment. The multi-tenant environment can include a tenant (e.g., one or more user accounts sharing common privileges with respect to an application instance) accessible by a particular set of client devices, as well as other tenants inaccessible to that set of client devices (e.g., access controlled to permit only access from other sets of client devices). For instance, in (or otherwise in connection with) the tenant accessible by a particular client system of one or more client devices, certain digital content items used by the queue priority management system 102 apply to that client system (e.g., the digital content items correspond to functions or infrastructure of the entity using the client system), with other tenants having other digital content items, and instances of the software components of the queue priority management system 102 described herein may only be available to the client system, with other tenants having access other instances of these software components. In additional or alternative embodiments, the queue priority management system 102 can be implemented on one or more computing systems operated by a single entity. For instance, the queue priority management system 102 (or portions of the queue priority management system 102) can be operated on a first server system controlled by the entity (e.g., via an on-premises installation of software components described herein), and can communicate with a second server system that is a client system controlled by the entity.

In some embodiments, the server system 104 support the queue priority management system 102 on the client device 106. For instance, the server system 104 generates/maintains the queue priority management system 102 and/or one or more components of the queue priority management system 102 for the client device 106. The server system 104 provides the generated queue priority management system 102 to the client device 106 (e.g., as a software application/suite). In other words, the client device 106 obtains (e.g., download) the queue priority management system 102 from the server system 104. At this point, the client device 106 are able to utilize the queue priority management system 102 to manage digital content items according to one or more system requirements frameworks independently from the server system 104.

In alternative embodiments, the queue priority management system 102 includes a web hosting application that allows the client device 106 to interact with content and services hosted on the server system 104. To illustrate, in one or more embodiments, the client device 106 access a web page supported by the server system 104. The client device 106 provide input to the server system 104 to perform data processing operations, and, in response, the queue priority management system 102 on the server system 104 performs operations to view/manage data associated with digital data processing. The server system 104 provide the output or results of the operations to the client device 106.

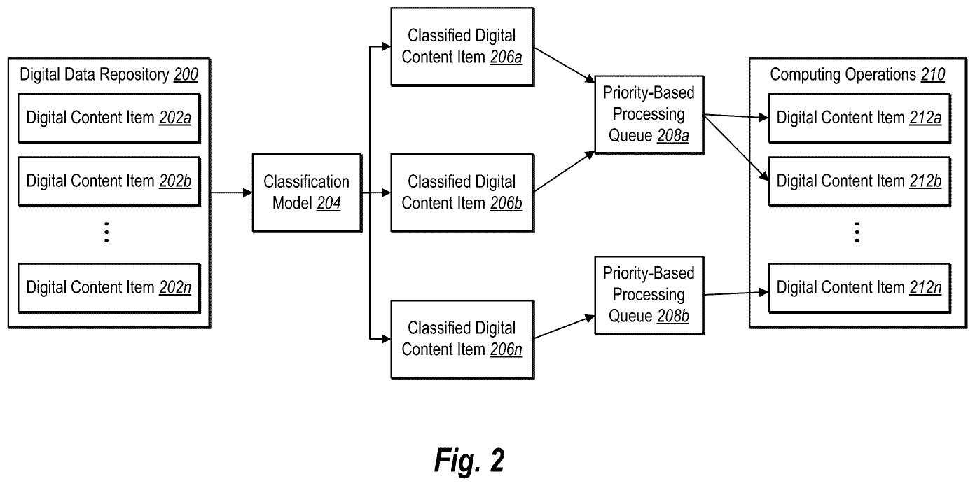

As mentioned, the queue priority management system 102 can manage data processing by prioritizing specific data types and/or data attributes via a plurality of priority-based processing queues. FIG. 2 illustrates an overview of the queue priority management system 102 utilizing information associated with digital content items to route the digital content items to a plurality of priority-based processing queues. Specifically, the queue priority management system 102 utilizes classifications generated by a classification model for the digital content items to determine priority levels of the digital content items. Furthermore, the queue priority management system 102 utilizes the priority levels of the digital content items to route the digital content items to the priority-based processing queues for determining an order for performing various computing operations on the digital content items.

As illustrated in FIG. 2, the queue priority management system 102 accesses a digital data repository 200 that includes a plurality of digital content items 202a-202n. In one or more embodiments, the digital content items 202a-202n are associated with an entity and may be related to one or more specific topics. For example, as mentioned, the digital content items 202a-202n may be subject to one or more system requirements frameworks. In some embodiments, a first set of data content items in the digital data repository 200 is subject to a first set of one or more system requirements frameworks and a second set of data content items in the digital data repository 200 is subject to a second set of one or more system requirements frameworks.

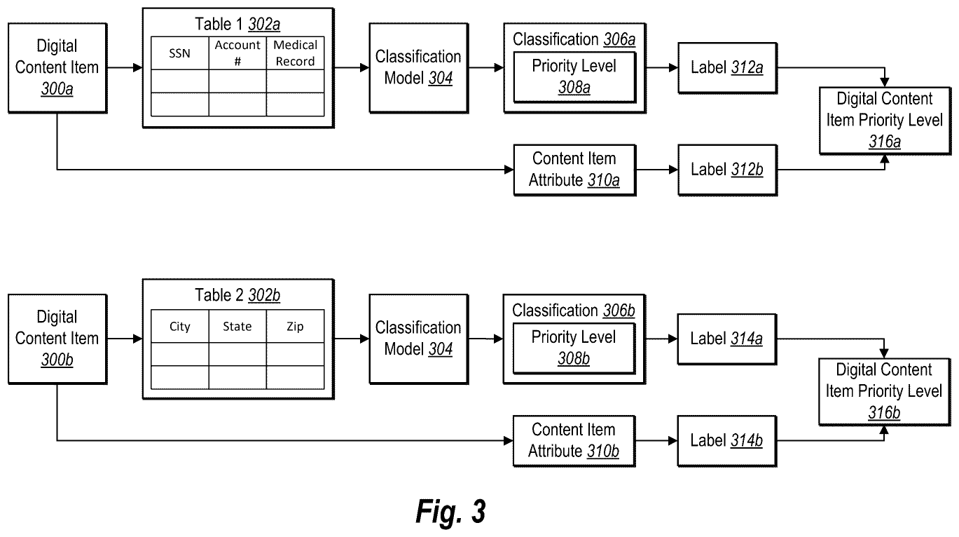

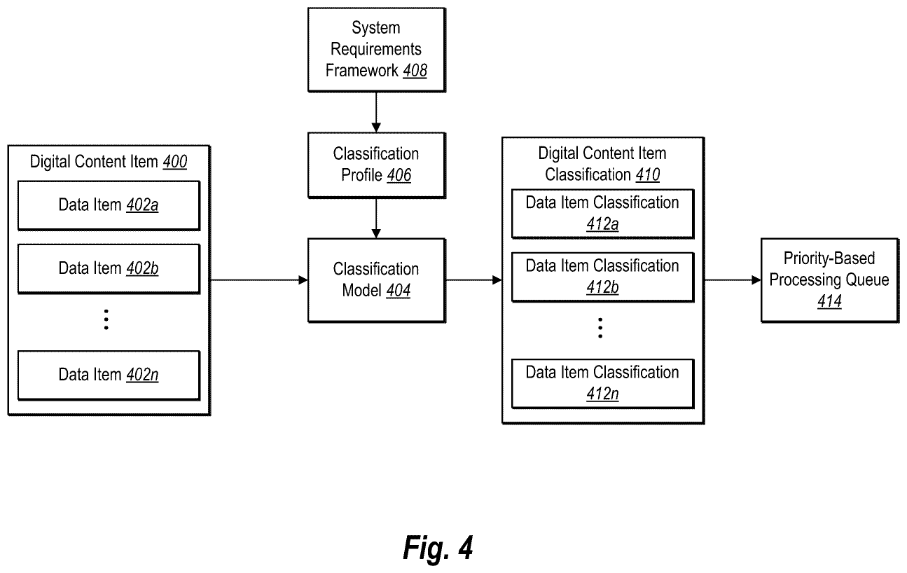

In one or more embodiments, the queue priority management system 102 generates classifications for the digital content items 202a-202n utilizing a classification model 204. Specifically, the queue priority management system 102 utilizes the classification model 204 to generate classifications for the digital content items 202a-202n according to the contents of each digital content item. Furthermore, in some embodiments, the queue priority management system 102 utilizes the classification model 204 to generate classifications for portions of a digital content item based on the attributes of each individual portion of the digital content item. FIGS. 3 and 4 and the corresponding description provide additional detail with respect to classifying digital content items.

As used herein, the term “classification model” refers to one or more computer functions that classify digital data into various categories. For example, a classification model processes digital data and outputs a classification for each digital data item according to a classification scheme. In some instances, the classification model includes a machine-learning model or neural network that learns to classify data into a set of categories based on the data types, risk levels, or other attributes of the data. In additional embodiments, the classification model includes a set of computer functions that utilizes predefined mappings to determine a category for each data item. In some embodiments, the classification model accesses a classification profile that provides mappings between specific data items and specific categories.

As illustrated in FIG. 2, the queue priority management system 102 utilizes the classifications of the digital content items 202a-202n to route the digital content items 202a-202n to various processing queues. In particular, the queue priority management system 102 determines classified digital content items 206a-206n based on classifications generated by the classification model 204. Additionally, the queue priority management system 102 routes the classified digital content item 206a-206n into a plurality of priority-based processing queues (e.g., a first priority-based processing queue 208a and a second priority-based processing queue 208b) based on priority levels associated with the classified digital content items 206a-206n. To illustrate, the queue priority management system 102 routes a first classified digital content item 206a and a second classified digital content item 206b into the first priority-based processing queue 208a. The queue priority management system 102 also routes an nth classified digital content item 206n into the second priority-based processing queue 208b.

As used herein, the terms “priority-based processing queue” and “processing queue” refer to a sequence of electronic requests for processing digital data via a server or a group of servers. For example, the server or a group of servers can process electronic requests from one or more computing devices or systems (e.g., including digital content items from a digital data repository) via a processing queue. In one or more embodiments, a processing queue also includes an initial queue, a plurality of sub-queues corresponding to one or more processing priorities, and a target queue. To illustrate, a processing queue can include the first priority-based processing queue 208a for processing high priority data, the second priority-based processing queue 208b for processing low priority data, and/or one or more additional priority-based processing queues for processing data of one or more additional priority levels. In some instances, a processing queue includes a sequence of requests for processing via a shared processing infrastructure. The queue priority management system 102 can separate requests from the initial queue into the plurality of sub-queues based on the priority levels of the corresponding digital content items.

In one or more embodiments, as illustrated in FIG. 2, the queue priority management system 102 utilizes the priority-based processing queues 208a-208b to determine an order for performing computing operations 210 on the digital content items 202a-202n. For instance, the queue priority management system 102 determines whether the first priority-based processing queue 208a includes any digital content items and inserts the digital content items into a target queue for the computing operations 210. To illustrate, the queue priority management system 102 determines a first digital content item 212a in a first position and a second digital content item 212b in a second position of the first priority-based processing queue 208a for performing the computing operations 210. Additionally, in response to determining that the first priority-based processing queue 208a is empty, the queue priority management system 102 accesses the second priority-based processing queue 208b and determines an nth digital content item 212n for performing the computing operations 210.

Accordingly, as illustrated in FIG. 2, the queue priority management system 102 determines priority levels of data for prioritizing processing and computing operations associated with the data. By categorizing data based on specific attributes in view of one or more system requirements frameworks, the queue priority management system 102 can efficiently determine a processing priority for the data. As an example, because certain types of data are more important to process quickly than others in view of a particular system requirements framework (e.g., according to HIPAA standards), the queue priority management system 102 can identify any digital content items that fail to comply with the system requirements framework. The queue priority management system 102 can move such digital content items to the front of the processing queue (e.g., by routing the digital content items to a higher priority-based processing queue) and perform one or more computing operations on the digital content items. To illustrate, the queue priority management system 102 can correct any deficiencies or configuration gaps in the digital content items (or processes associated with the digital content items) by accessing digital content items with a higher priority to initiate one or more computing operations and/or to present information associated with the digital content items within a graphical user interface of a client device.

FIG. 3 illustrates an example of the queue priority management system 102 determining priority levels of digital content items. In particular, the queue priority management system 102 parses digital content items to determine the contents of each digital content item. For example, as illustrate in FIG. 3, the queue priority management system 102 accesses a first digital content item 300a from a digital data repository. The queue priority management system 102 also determines the content of the first digital content item 300a. To illustrate, the first digital content item 300a includes a first table 302a of data including information associated with a particular topic. As an example, the first table 302a includes personally identifiable information from confidential documents, and thus may include items such as social security numbers, medical records, account numbers, or other details that are subject to one or more system requirements frameworks.

According to one or more embodiments, the queue priority management system 102 performs search operations within digital content items for keywords, phrases, and other data that indicate sensitive information (e.g., by searching for names, location data, contact information, medical histories, banking information, or phrases such as “social security number” or “SSN”). In additional embodiments, the queue priority management system 102 performs search operations within metadata associated with digital content items to identify specific mentions of sensitive information, flags indicating sensitive information, or other indicators of sensitive information. To illustrate, the queue priority management system 102 can determine that a digital content item includes sensitive information based on a file type or file extension of the digital content item or an association of the digital content item with other digital content items.

In one or more embodiments, as illustrated, the queue priority management system 102 also accesses a second digital content item 300b from the digital data repository. The queue priority management system 102 determines the content of the second digital content item 300b. For example, FIG. 3 illustrates that the second digital content item 300b includes a second table 302b of data including information associated with a topic. In some embodiments, the second table 302b includes information associated with the same topic as the first table 302a or a different topic. Furthermore, the second table 302b can include address information or location information for people or entities that may be subject to one or more system requirements frameworks. In alternative embodiments, the data in the second table 302b may not be subject to any system requirements frameworks.

As illustrated in FIG. 3, the queue priority management system 102 utilizes a classification model 304 to categorize the first digital content item 300a and the second digital content item 300b. For example, the queue priority management system 102 utilizes the classification model 304 to analyze the contents of the first digital content item 300a (e.g., the first table 302a) to generate a first classification 306a. Additionally, the queue priority management system 102 utilizes the classification model 304 to analyze the contents of the second digital content item 300b (e.g., the second table 302b) to generate a second classification 306b.

Furthermore, in one or more embodiments, each classification corresponding to a digital content item is associated with a priority level. Specifically, the queue priority management system 102 utilizes the classification model 304 to determine priority levels of each digital content item based on predetermined priority levels for specific categories of data. To illustrate, the queue priority management system 102 determines a first priority level 308a indicating whether the first classification 306a is high priority, medium priority, low priority, or other priority level as may be determined in connection with a particular implementation. As an example, the queue priority management system 102 determines that the first table 302a is classified as high priority and the second table 302b is classified as low priority. Similarly, the queue priority management system 102 determines a second priority level 308b based on the second classification 306b.

According to one or more embodiments, the queue priority management system 102 can utilize the classification model 304 to analyze data and generate a confidence score indicating whether a particular digital content item includes sensitive information (e.g., based on attributes of sensitive information in training data learned by the machine-learning model). For example, the queue priority management system 102 generates a confidence score for a digital content item by providing the digital content item to a machine-learning model that extracts features from the digital content item (e.g., text data, image data) and generates the confidence score based on the features. In some embodiments, the queue priority management system 102 generates a confidence score for a digital content item by detecting certain data types in the digital content item and assigning a weighted value to each data type according to one or more previously determined mappings. To illustrate, the queue priority management system 102 can assign a first value to a first data type (e.g., a social security number) detected in a digital content item and a second value to a second data type (e.g., a first name) detected in the digital content item. The queue priority management system 102 can utilize the highest value assigned to data types detected in a digital content item (e.g., the first value corresponding to the first data type). In one or more embodiments, the classification model 304 determines relationships between known assets and a newly discovered asset and uses the relationships to generate a confidence score that the new asset includes sensitive information. Additionally, the queue priority management system 102 can use user input to further refine the confidence score, for example, by increasing the confidence score in response to user feedback indicating that a classification based on the confidence score is correct.

According to additional embodiments, the queue priority management system 102 utilizes additional information to determine a priority level associated with each digital content item. In particular, the queue priority management system 102 determines one or more content item attributes of the digital content items. For instance, the queue priority management system 02 determines a first content item attribute 310a associated with the first digital content item 300a. To illustrate, the queue priority management system 102 determines that the first digital content item 300a includes a security attribute including, but not limited to an access level indicating that the first digital content item 300a is locked (e.g., password protected, encrypted, or otherwise unavailable to one or more users) or open (e.g., accessible to any user). The queue priority management system 102 also determines a second content item attribute 310b associated with the second digital content item 300b.

As illustrated in FIG. 3, the queue priority management system 102 utilizes the classifications and/or other attributes of the digital content items to generate one or more labels for the digital content items. For example, the queue priority management system 102 generates a plurality of labels for the first digital content item 300a, such as by generating metadata associated with the first digital content item 300a. To illustrate, the queue priority management system 102 generates a first label 312a indicating the first classification 306a and a second label 312b indicating the first content item attribute 310a. Additionally, the queue priority management system 102 generates labels for the second digital content item 300b including a first label 314a representing the second classification 306b and a second label 314b indicating the second content item attribute 310b. Furthermore, although FIG. 3 illustrates that the queue priority management system 102 generates a plurality of labels for each digital content item, in alternative embodiments, the queue priority management system 102 generates a single label for each digital content item (e.g., based on a corresponding classification).

In one or more embodiments, the queue priority management system 102 utilizes the labels associated with each digital content item to determine an overall priority level for each digital content item. Specifically, as illustrated, each classification is associated with a specific priority level indicating an importance for each digital content item based on the contents of the digital content item. Additionally, the queue priority management system 102 can determine that specific attributes of the digital content items also affect the importance of the digital content items. For instance, the queue priority management system 102 can determine that digital content items with a specific classification may have different priority levels based on the additional content item attribute(s).

Thus, the queue priority management system 102 can generate a first digital content item priority level 316a (e.g., via a first metadata flag) based on the first label 312a and the second label 312b of the first digital content item 300a. The queue priority management system 102 can also generate a second digital content item priority level 316b (e.g., via a second metadata flag) based on the first label 314a and the second label 314b of the second digital content item 300b. To illustrate, the queue priority management system 102 can determine that the a first digital content item including confidential information may be lower priority than a second digital content item including confidential information if the first digital content item is locked or encrypted and the second digital content item is open or unencrypted. In some embodiments, the queue priority management system 102 determines the priority levels of digital content items by weighting the labels associated with the digital content items (e.g., by assigning a first weight value to the first label 312a and a second weight value to the second label 312b). Additionally, the queue priority management system 102 can determine an average priority level associated with each label for determining the overall priority level.

In one or more embodiments, the priority levels associated with digital content items include a numerical value or other value along a scale of values. For example, the queue priority management system 102 can assign a value from 1-to-3 to a digital content item based on a corresponding classification (and in some cases a corresponding access attribute or other attribute). To illustrate, a higher value on the scale indicates a higher priority (e.g., with a value of 3 indicating a highest priority). Accordingly, the queue priority management system 102 can determine any number of priority levels based on a number of priority-based processing queues as corresponds to a particular embodiment.

As an example, the queue priority management system 102 can determine that a first digital content item including sensitive information that has limited/restricted access has a medium priority level and a second digital content item including sensitive information that has open access has a high priority level. Thus, the queue priority management system 102 can prioritize processing of the open access digital content item over processing of the restricted access digital content item. Furthermore, the queue priority management system 102 can determine that a digital content item that does not contain sensitive information has a low priority level, regardless of access level. Alternatively, the queue priority management system 102 can determine that a digital content item that does not have sensitive information may have a medium priority level in response to determining that the digital content item has an open access level.

In additional embodiments, the queue priority management system 102 determines different priority levels based on different levels of sensitive information in digital content items. For instance, the queue priority management system 102 may determine that a first digital content item including a first type of information has a first sensitivity level and a second digital content item including a second type of information has a second sensitivity level lower than the first sensitivity level. Accordingly, the queue priority management system 102 can identify confidential/sensitive information with different sensitivity levels based on the type of data. As an example, the queue priority management system 102 can determine that data covered by HIPAA has a higher sensitivity level than personally identifiable information that is not covered by a specific governmental regulation (e.g., information typically included in a social networking profile).

In one or more embodiments, the queue priority management system 102 determines a priority level for a digital content item based on a plurality of classifications of separate portions of the digital content item. FIG. 4 illustrates an example of the queue priority management system 102 generating classifications for different portions of a single digital content item. Additionally, FIG. 4 illustrates that the queue priority management system 102 routes the digital content item to a particular processing queue based on the classifications of the portions of the digital content item.

Specifically, as illustrated, the queue priority management system 102 determines a digital content item 400 including a plurality of separate portions. For example, the digital content item 400 includes a plurality of data items 402a-402n that can each include a separate word, phrase, character string, image, media item, or other individually identifiable piece of content. Accordingly, in one or more embodiments, the queue priority management system 102 scans and parses the digital content item 400 (e.g., utilizing a natural language processing model, OCR model, or other content processing model) to determine the data items 402a-402n.

In response to extracting the data items 402a-402n from the digital content item 400, the queue priority management system 102 classifies the separate portions. For example, FIG. 4 illustrates a classification model 404 for classifying the data items 402a-402n into various categories. According to one or more embodiments, the queue priority management system 102 utilizes the classification model 404 to classify the data items 402a-402n according to a classification profile 406. More specifically, the classification profile 406 includes mappings between specific types of data and categories. To illustrate, the classification profile 406 can include terms, phrases, character strings, data patterns, or functions/processes (e.g., lookup lists, regular expressions) for identifying specific data types in digital content items. Additionally, the classification profile 406 can include a mapping of each term, phrase, etc., to a specific category.

In one or more embodiments, the queue priority management system 102 determines the classification profile 406 in connection with a system requirements framework 408. In particular, the queue priority management system 102 can determine the classification profile 406 according to input from one or more computing devices indicating specific data types that are subject to the system requirements framework 408. In additional embodiments, the queue priority management system 102 determines the classification profile 406 based on a default set of categories corresponding to the system requirements framework 408. Accordingly, the queue priority management system 102 can determine the classification profile 406 based on user input indicating mappings, automatically determined mappings, or a combination of user-selected mappings and automatically determined mappings.

In at least some embodiments, the queue priority management system 102 utilizes the classification model 404 with the classification profile 406 to determine a digital content item classification 410. Specifically, as illustrated in FIG. 4, the queue priority management system 102 can determine a plurality of data item classifications 412a-412n based on the data items 402a-402n in the digital content item 400. For instance, the queue priority management system 102 utilizes the classification model 404 to generate a first data item classification 412a for a first data item 402a indicating that the first data item 402a corresponds to a specific category (e.g., data type) according to the classification profile 406. As an example, the first data item classification 412a indicates that the first data item 402a includes a social security number, which may be a highly confidential data item subject to the system requirements framework 408.

Furthermore, in some embodiments, the queue priority management system 102 determines a priority-based processing queue 414 for the digital content item 400 according to the digital content item classification 410. In particular, the queue priority management system 102 can determine the priority-based processing queue 414 according to a priority level corresponding to the digital content item classification 410. For example, the queue priority management system 102 can determine the overall priority level of the digital content item 400 based on an overall classification of the digital content item 400. To illustrate, the queue priority management system 102 can determine the digital content item classification 410 based on a highest priority level corresponding to the data item classifications 412a-412n (e.g., the digital content item classification 410 corresponds to a high priority level in response to determining that at least one data item classification corresponds to a high priority level). The queue priority management system 102 can thus route the digital content item 400 to the priority-based processing queue 414 based on the priority level of the digital content item classification 410 for processing (e.g., performing one or more computing operations on) the digital content item 400 according to an importance of the digital content item 400.

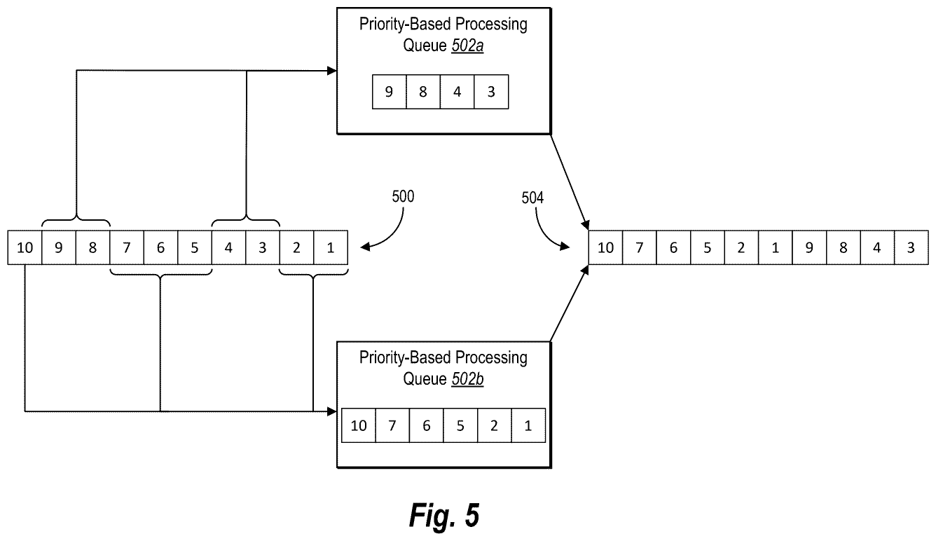

FIG. 5 illustrates an example of a processing queue including a plurality of digital content items with routing according to priority levels of the digital content items. Specifically, the queue priority management system 102 utilizes information associated with the digital content items to categorize the digital content items and determine a modified processing order based on the categories. For example, FIG. 5 illustrates an initial processing queue 500, a plurality of priority-based processing queues (e.g., a first priority-based processing queue 502a and a second priority-based processing queue 502b), and a target processing queue 504.

In particular, FIG. 5 illustrates that the initial processing queue 500 includes a plurality of digital content items in a first order. To illustrate, the first order of digital content items in the initial processing queue 500 can be based on a request order. In one or more embodiments, the queue priority management system 102 receives a plurality of requests to process digital content items from one or more computing systems (e.g., one or more tenant systems). The queue priority management system 102 can also insert the corresponding digital content items into the initial processing queue 500 in the order in which the queue priority management system 102 receives the requests (e.g., “1” being the first received digital content item and “10” being the last received digital content item).

In one or more embodiments, the queue priority management system 102 utilizes a classification model to generate classifications for the digital content items in the initial processing queue 500. For example, the queue priority management system 102 generates classifications for all digital content items inserted into the initial processing queue 500. In some embodiments, the queue priority management system 102 determines the classifications for the digital content items as the queue priority management system 102 inserts the digital content items into the initial processing queue 500 (e.g., in real-time) while continuing to insert additional digital content items into the initial processing queue 500 (e.g., in parallel operations). Such parallel operations can be useful when processing large amounts of data (e.g., terabytes or petabytes of data).

Furthermore, the queue priority management system 102 routes the digital content items into the priority-based processing queues (e.g., the first priority-based processing queue 502a or the second priority-based processing queue 502b) according to the classifications. For example, as illustrated, the queue priority management system 102 inserts a first subset of digital content items from the initial processing queue 500 into the first priority-based processing queue 502a based on a priority level associated with classifications of the first subset. Additionally, the queue priority management system 102 inserts a second subset of digital content items from the initial processing queue 500 into the second priority-based processing queue 502b based on a priority level associated with classifications of the second subset.

In one or more embodiments, the queue priority management system 102 processes the digital content items in the priority-based processing queues according to the priority levels of the corresponding priority-based processing queues. In particular, in response to determining that the first priority-based processing queue 502a is associated with a higher priority level than the second priority-based processing queue 502b, the queue priority management system 102 moves the digital content items in the first subset to the target processing queue 504 for performing one or more computing operations. Additionally, once the queue priority management system 102 has determined that the first priority-based processing queue 502a has no more digital content items (e.g., the queue is empty), the queue priority management system 102 moves the second subset of digital content items from the second priority-based processing queue 502b to the target processing queue 504.

Additionally, in some embodiments, the queue priority management system 102 continues monitoring the separate priority-based processing queues for additional content items while processing digital content items in the target processing queue 504. For example, while processing one or more digital content items in the target processing queue 504, the queue priority management system 102 can determine that an additional digital content item is inserted into the first priority-based processing queue 502a corresponding to a higher priority level. The queue priority management system 102 can retrieve the additional digital content item and insert it into the target processing queue 504 in front of any digital content items with a lower priority level. Thus, the queue priority management system 102 can continue processing higher priority digital content items as long as there are higher priority digital content items in any of the priority-based processing queues.

Although FIG. 5 illustrates that the queue priority management system 102 moves digital content items from separate priority-based processing queues to a target processing queue, in other embodiments, the queue priority management system 102 processes the digital content items directly from the separate priority-based processing queues. Specifically, rather than inserting digital content items into priority-based processing queues from an initial queue and then moving the digital content items into a target queue for further computing operations, the queue priority management system 102 can perform computing operations on digital content items within the priority-based processing queues. For example, the queue priority management system 102 can monitor each of the priority-based processing queues to determine whether a highest priority processing queue has digital content items and continue processing digital content items while the highest priority processing queue is not empty. In response to determining that the highest priority processing queue is empty, the queue priority management system 102 can move to the next highest priority processing queue. In response to determining that a new digital content item is added to the highest priority processing queue, the queue priority management system 102 can move back to the highest priority processing queue to process the new digital content item and any additional digital content items in the highest priority processing queue.

In one or more embodiments, the queue priority management system 102 processes data in batches of digital content items. For example, the queue priority management system 102 can process digital content items based on a predetermined number of electronic requests (e.g., a default batch size) in a selected priority-based processing queue. In alternative embodiments, the processed requests include a variable batch size, such as by processing all of the requests in the high priority processing queue in a single batch. For instance, the queue priority management system 102 can provide all of the requests in the high priority processing queue to a processor in response to determining that a number of requests in the high priority processing queue is below a default batch size or that an estimated processing time for the requests in the priority-based processing queue is below a threshold time.

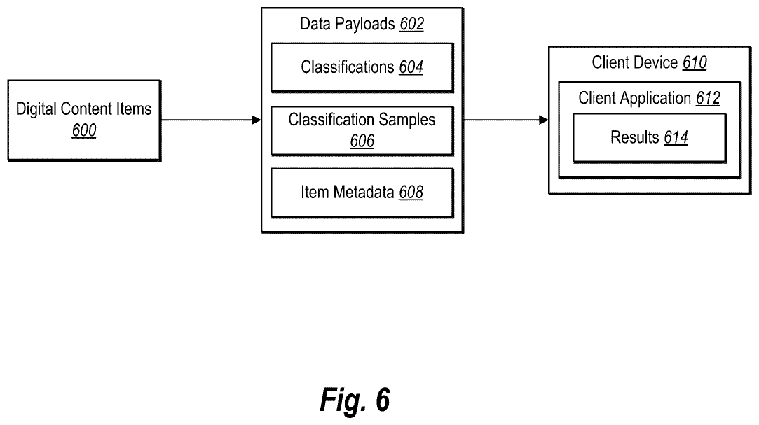

In one or more embodiments, the queue priority management system 102 provides information associated with prioritization of digital content item processing for display at one or more client devices for one or more users. FIG. 6 illustrates an example of the queue priority management system 102 providing results of data prioritization based on data classification. In particular, the queue priority management system 102 generates data payloads including information associated with digital content items for providing within a graphical user interface.

As illustrated in FIG. 6, the queue priority management system 102 determines digital content items 600 for processing via a plurality of priority-based processing queues. In particular, in connection with determining priority levels of digital content items for processing via priority-based processing queues, the queue priority management system 102 also determines a plurality of additional details associated with the digital content items 600. To illustrate, the queue priority management system 102 can generate data payloads 602 corresponding to the digital content items 600 for providing information about the digital content items 600 to one or more computing devices associated with performing various computing operations on the digital content items 600.

According to one or more embodiments, the queue priority management system 102 determines classifications 604 corresponding to the digital content items 600. For example, as previously described, the queue priority management system 102 determines the classifications 604 indicating data types or specific attributes of the digital content items utilizing a classification model. As illustrated in FIG. 6, the queue priority management system 102 also determines classification samples 606 associated with the classifications 604 of the digital content items 600. To illustrate, the queue priority management system 102 selects a subset of portions of a digital content item that correspond to a classification of the digital content item as one or more samples of a data type. Specifically, the queue priority management system 102 can select a term, phrase, or data pattern in a digital content item indicating a high priority data item (e.g., a social security number) as a sample of a corresponding classification of the digital content item.

In additional embodiments, the queue priority management system 102 determines item metadata 608 corresponding to the digital content items 600. In particular, the queue priority management system 102 determines additional details associated with the digital content items that may not affect the classifications 604 of the digital content items. For instance, the queue priority management system 102 determines file sizes, owners (e.g., user accounts assigned to the digital content items 600), user accounts with access to the digital content items 600, creation/modification times, data dependencies (e.g., with other digital content items), or other details.

As illustrated in FIG. 6, the queue priority management system 102 generates the data payloads 602 including the details associated with the digital content items 600 (e.g., the classifications 604, the classification samples 606, and the item metadata 608). In one or more embodiments, the data payloads 602 include JavaScript Object Notation (“JSON”) payloads including the details associated with the digital content items 600. In alternative embodiments, the data payloads include a different type of data object including a format corresponding to a different type of transmission protocol.

The queue priority management system 102 can provide the data payloads 602 to a client device 610 for displaying information related to the classification and processing of the digital content items 600 within a client application 612. Specifically, the queue priority management system 102 provides results 614 of the prioritization of the digital content items 600 in connection with routing the digital content items 600 via priority-based processing queues. To illustrate, the client device 610 displays the results 614 including notifications of high priority data, computer operations performed on the digital content items 600, configuration gaps associated with implementing controls based on system requirements frameworks, and/or other information based on the data payloads 602.

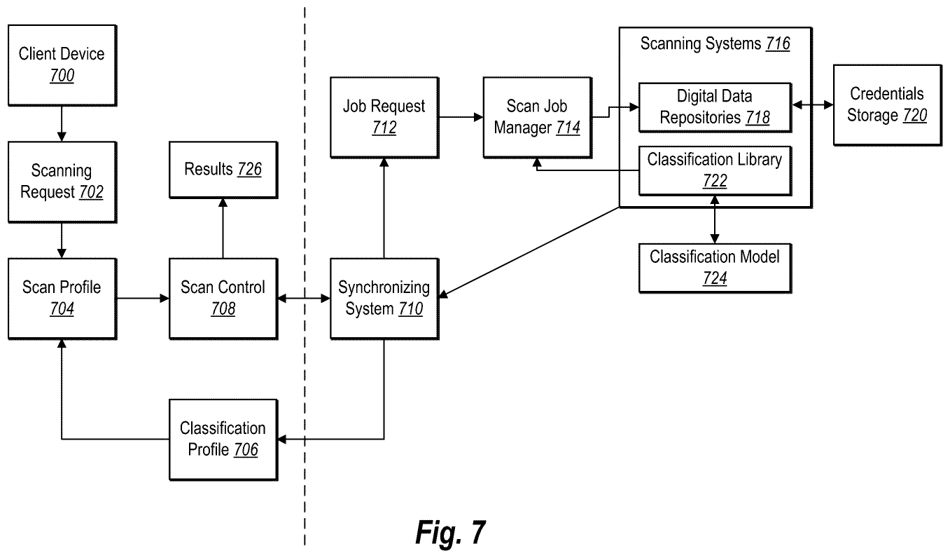

FIG. 7 illustrates an example architecture of the queue priority management system 102 performing operations to prioritize digital content items for scanning data associated with an entity. In one or more embodiments, as illustrated, a first portion of the queue priority management system 102 operates at a cloud-based computing system. Additionally, a second portion of the queue priority management system 102 operates on premises (e.g., on one or more computing devices or servers associated with an entity).

In one or more embodiments, the queue priority management system 102 includes a client device 700 that initiates a scanning request 702 to scan a dataset including a plurality of digital content items. In one or more embodiments, the queue priority management system 102 determines a scan profile 704 indicating one or more instructions for scanning the dataset. Furthermore, in some embodiments, the scan profile 704 includes (or is otherwise based on) a classification profile 706 indicating priority levels for classified content from the dataset according to one or more system requirements frameworks. As also illustrated, in one or more embodiments, the queue priority management system 102 provides the scan profile 704 to a scan control 708 that initiates the scanning request in connection with a portion of the queue priority management system 102 at computing devices of the entity.

As used herein, a “request” refers to a communication from a first computing device to a second computing device to perform a computing operation. In one or more embodiments, an electronic request from a computing system includes a packet or message sent to the queue priority management system (e.g., via an API provided by the queue priority management system) and including processing instructions to perform one or more operations via one or more recipient processors and/or processing threads. For instance, an electronic request can include a request to extract data, modify data, or otherwise perform operations on data in one or more digital content items.

In additional embodiments, the queue priority management system 102 utilizes the scan control 708 to provide the scanning request 702 with the scan profile 704 to a synchronizing system 710 at computing devices of the entity. For instance, the synchronizing system 710 can continuously poll the scan control 708 for new job requests. In some embodiments, the synchronizing system 710 provides the classification profile 706 for including with the scan profile 704. As illustrated in FIG. 7, the queue priority management system 102 deploys the synchronizing system 710 (with additional components) at the computing device(s) of the entity behind network security controls (e.g., outside one or more firewalls) for accessing digital content items associated with the entity (e.g., at the computing devices or via one or more remote computing devices through the firewall(s)).

In one or more embodiments, the queue priority management system 102 utilizes the synchronizing system 710 to submit a job request 712 to a scan job manager 714 that manages the initiation and execution of scan jobs at the computing device(s) of the entity. For example, the queue priority management system 102 utilizes the scan job manager 714 to communicate with scanning systems 716 that scan digital data repositories 718 including a dataset associated with the job request 712. In additional embodiments, the scanning systems 716 include functions, scripts, or applications integrated with the digital data repositories 718 to access and/or modify digital content items in the dataset. To illustrate, the scanning systems 716 communicate with a database management system, a cloud storage devices or local storage devices, and/or storage accounts (e.g., utilizing credentials in a credentials storage 720) to access digital content items.

Furthermore, as illustrated, the scanning systems 716 include a classification library 722 that communicates with a classification model 724 (e.g., a named entity recognition model or other natural language processing model) to determine classifications associated with the digital content items. In one or more embodiments, the classification library 722 also communicates with the scan job manager 714 to obtain label definitions for labeling digital content items based on classifications generated by the classification model 724. Additionally, the classification library 722 can determine the label definitions according to information from the classification profile 706 and scan profile 704.

According to one or more embodiments, in response to executing the job request 712 utilizing the scanning systems 716, the queue priority management system 102 utilizes the scanning systems 716 to communicate results data to the synchronizing system 710. For example the scanning systems 716 can provide a catalog and classification results corresponding to the digital content items indicated in the job request 712 to the synchronizing system 710. Additionally, as illustrated, the synchronizing system 710 can provide the catalog and classification results to the scan control 708, which provides the results 726 for display and analysis via one or more client devices (e.g., the client device 700).

Although FIG. 7 illustrates that the queue priority management system 102 utilizes a plurality of components within a cloud-based system and a plurality of components at on premises devices of a single entity, the queue priority management system 102 can implement data prioritization scanning for a plurality of entities. To illustrate, the queue priority management system 102 can integrate separate synchronizing systems, scan job managers, and scanning systems at computing devices of each entity that issues a scanning request to the components within the cloud-based system. For instance, the queue priority management system 102 can utilize the scan control 708 to manage scanning requests for a plurality of entities and communicate with a plurality of separate synchronizing systems at different computing devices of the different entities.

Additionally, as mentioned above, the queue priority management system 102 can utilize a first set of operations to manage a scan profile 704 and a scan control 708 for implementing a scanning request 702 and providing results 726 of the scanning request via a client device 700 at a first computing system (e.g., a cloud-based computing system). Additionally, the queue priority management system 102 can utilize a second set of operations to manage a synchronizing system 710, a scan job manager 714, and scanning systems 716 to scan data in digital data repositories 718 and classify the data utilizing a classification model 724 at a second computing system (e.g., one or more computing devices or servers at one or more locations of an entity). In some embodiments, the queue priority management system 102 utilizes one or more other configurations, such that one or more portions described above in connection with the first computing system are instead part of the second computing system, or vice-versa. Thus, the queue priority management system 102 can utilize several different computing devices (e.g., cloud-based devices or on premises devices) to perform various operations associated with classifying and routing digital content items. In additional embodiments, the queue priority management system 102 performs one or more operations described herein by utilizing one or more software applications at one or more computing devices to generate instructions that cause one or more additional computing devices to perform one or more computing operations. As an example, a cloud-based computing application classifies a digital content item by generating instructions that cause a server on premises of an entity to utilize a classification model to generate a classification for the digital content item.

In one or more embodiments, the components deployed on the computing device(s) of the entity are part of a discovery agent for detecting data sources, datasets, and data types via data extraction and classification. The queue priority management system can utilize the discovery agent to identify a data source, scan the data source, tag the data source (e.g., tag data in the data source), and send and classify the respective set of data in accordance with the tagged data. In some instances, by utilizing the discovery agent, the queue priority management system generates metadata associated with the digital content items to indicate results of the scanning and classification by the discovery agent. Additionally, the discovery agent can include one or more virtual machines for storing data and/or including/executing scanning operations or classifying operations.

In additional embodiments, the queue priority management system 102 configures the discovery agent to reduce an impact on a performance of the computing devices, servers, etc. For instance, the queue priority management system can configure the discovery agent to utilize bandwidth throttling techniques, such as by limiting scanning and other processing steps to non-peak times. The queue priority management system can also configure the discovery agent to limit performance of such operations to backup applications and data storage locations (e.g., by using sampling techniques to decrease a number of files to scan during the data discovery process).

In additional embodiments, the queue priority management system 102 generates data objects for each dataset or group of data in a digital data repository. For example, in response to determining that a particular set of data is a training dataset associated with a particular artificial intelligence model, the queue priority management system can generate a data object for the dataset. The queue priority management system can also assign attributes to the data object based on attributes of the dataset. To illustrate, the queue priority management system can store information with the data object indicating a purpose of the dataset, a priority level or data type of the dataset, or one or more other data components associated with the dataset (e.g., an artificial intelligence model). The queue priority management system can also classify the data object associated with the dataset into a corresponding category (e.g., based on the priority level or data type).

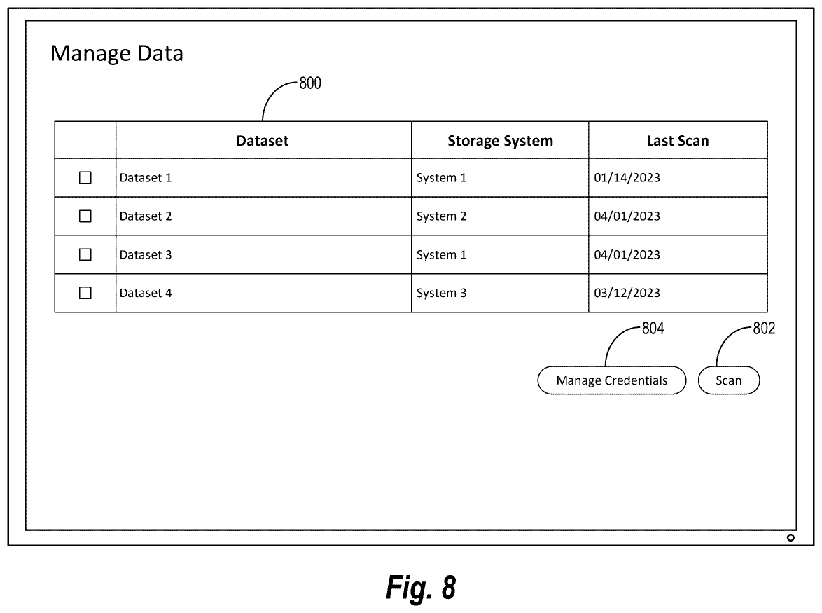

As mentioned, the queue priority management system 102 can provide information associated with data prioritization in data scans for display via graphical user interfaces of client devices. FIGS. 8-10 illustrate graphical user interfaces of client devices for initiating and managing scanning requests for one or more datasets associated with an entity. For example, FIG. 8 illustrates a graphical user interface of a client device for managing a scanning request for one or more datasets.

As illustrated in FIG. 8, the client device displays a list 800 of datasets associated with an entity. In particular, the list 800 of datasets can include information indicating an identifier associated with each dataset, a storage system for each dataset, and a most recent scan date. To illustrate, the client device can display a storage location or application (e.g., a cloud storage application) corresponding to a particular dataset. In some embodiments, the client device can provide tools for updating information associated with the datasets, adding one or more datasets, selecting one or more datasets, modifying one or more datasets, and/or removing one or more datasets.

Additionally, the client device can also display a first element 804 corresponding to an option to manage credentials for accessing the datasets. Specifically, as previously mentioned, the queue priority management system 102 can utilize a credential storage to access datasets for scanning digital content items in the datasets. The client device can provide tools for adding, modifying, or removing credentials associated with the datasets. For example, the client device can provide an option to add, modify, or change passwords, tokens, or other credentials associated with accessing the datasets.

FIG. 8 also illustrates that the client device displays a second element 802 for initiating a scan associated with one or more datasets. To illustrate, in response to determining a selection of one or more datasets in the list 800, the client device can provide the selected dataset(s) to the queue priority management system 102 to initiate a scanning request for the selected dataset(s). In response to the scanning request, the queue priority management system 102 can initiate the scanning request and begin classifying digital content items in the dataset(s) to route the digital content items to a plurality of priority-based processing queues.

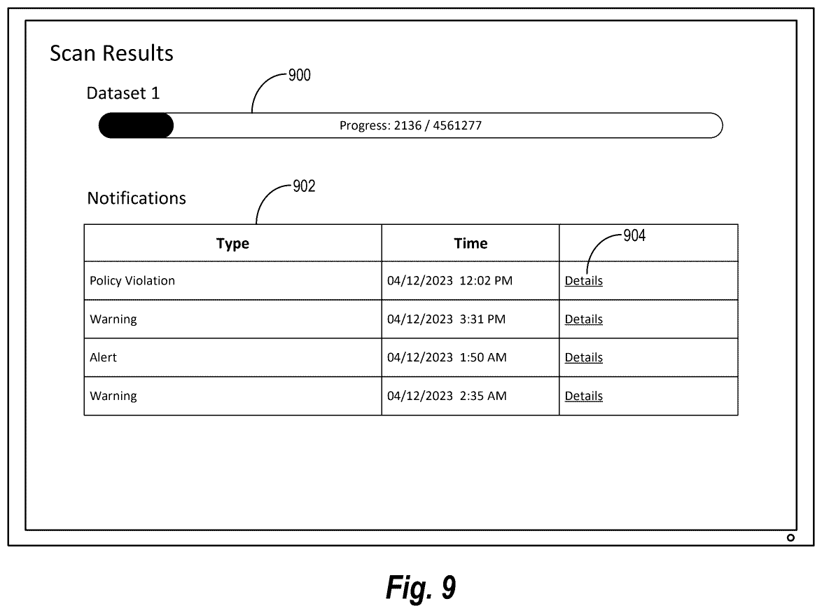

FIG. 9 illustrates a graphical user interface of a client device for presenting results associated with a scanning request. In particular, the client device can display a progress bar 900 indicating a completion progress of a scanning request for a dataset. For instance, the client device can provide an indication of the number of digital content items (e.g., files) scanned and a total number of digital content items remaining.

In some embodiments, the client device can also provide a notification list 902 indicating one or more notifications associated with scanned digital content items. To illustrate, the client device displays the notification list 902 including policy violations, warnings, alerts, or other relevant information associated with digital content items according to the classifications of the digital content items. For example, the queue priority management system 102 can determine whether a specific classification of a digital content item indicates a violation or possible violation based on a system requirements framework (e.g., based on a priority level of a digital content item meeting a priority threshold level). Specifically, the queue priority management system 102 can determine (e.g., based on a classification profile) that one or more digital content items include data items that violate the system requirements framework or otherwise include information that may violate (or cause a violation) based on formatting, encryption, or other details associated with the digital content items.

In one or more embodiment, the client device also displays details associated with each notification within the notification list 902. For example, the client device can display a time at which the queue priority management system 102 provided each notification for display at the client device. To illustrate, in response to classifying a digital content item and determining that the digital content item has a specific priority level, the queue priority management system 102 can route the digital content item to the corresponding priority-based processing queue and provide the notification to the client device for display within the notification list 902. The queue priority management system 102 can continue scanning additional digital content items after providing the notification to the client device.

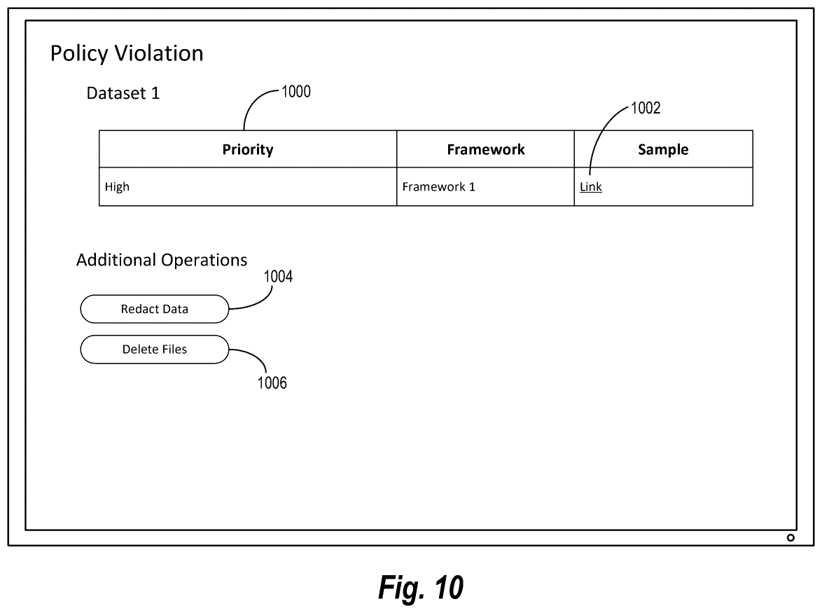

In some embodiments, the client device also displays a details link 904 that redirects the client device to a detailed graphical user interface for the corresponding notification. FIG. 10 illustrates a client device displaying a detailed graphical user interface for a notification in response to a selection of the details link 904. Specifically, the client device of FIG. 10 displays a details table 1000 including additional information associated with the corresponding notification. For instance, the details table 1000 can include a priority level associated with the notification, a system requirements framework covering the detected data in the digital content item (or in a plurality of digital content items), and a sample link 1002 to a sample corresponding to the detected data. Additionally, the client device can display a position of data in one or more priority-based processing queues based on the corresponding priority levels along with an estimated processing time for each piece of data. In one or more embodiments, the sample link 1002 displays an overlay or a separate graphical user interface including an instance of a data item that violates the system requirements framework within a digital content item (or a plurality of digital content items).

In one or more embodiments, the queue priority management system 102 also provides tools for performing computing operations based on detected violations of a system requirements framework. For example, FIG. 10 illustrates that the client device displays a first element 1004 to redact data from one or more digital content items. To illustrate, in response to a selection of the first element 1004, the queue priority management system 102 accesses a plurality of digital content items that include the data items associated with a violation of a system requirements framework and redacts the data items from the digital content items. As an example, the queue priority management system 102 can redact a plurality of social security numbers from digital content items that the queue priority management system 102 determined violated a system requirements framework.

Furthermore, the client device of FIG. 10 displays a second element 1006 to delete files that include data items that violate a system requirements framework. Accordingly, in response to a selection of the second element 1006, the queue priority management system 102 determines all digital content items that include a data item corresponding to the notification and deletes the identified digital content items. In some embodiments, the queue priority management system 102 can implement automated computing operations to modify additional digital content items that are discovered to include the indicated data items for digital content items that are yet to be scanned. Thus, the queue priority management system 102 can establish automated rules for modifying digital content items based on one or more notifications presented within a client device.

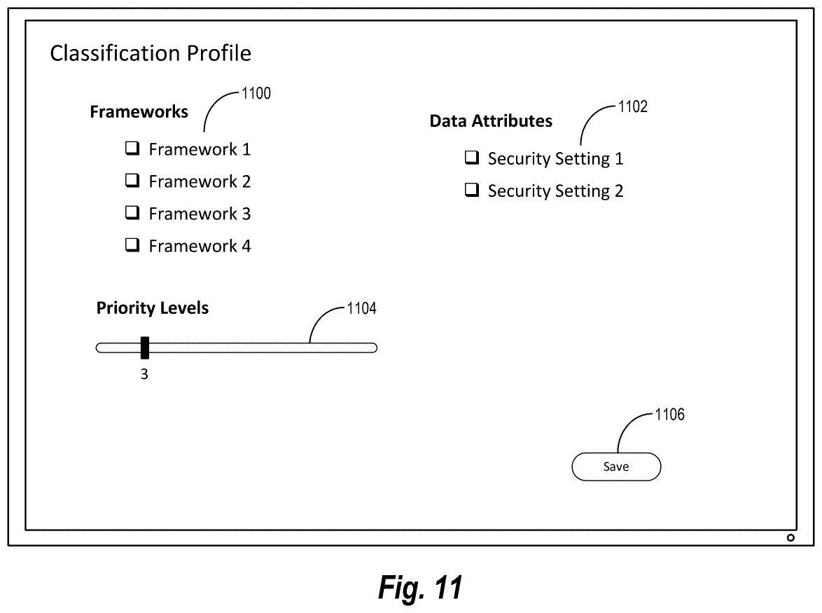

As mentioned, the queue priority management system 102 can determine a classification profile for an entity in connection with a scanning request for a dataset. FIG. 11 illustrates a graphical user interface of a client device for establishing one or more parameters of a classification profile. For example, the client device displays a set of system requirements frameworks for determining various controls indicating requirements for handling data types. Accordingly, the client device can determine a selected framework 1100 that indicates specific data types that may be subject to the requirements of a corresponding system requirements framework. In some embodiments, the queue priority management system 102 determines one or more classifications and/or priority levels based on the selected framework 1100.

In one or more embodiments, the queue priority management system 102 also generates recommendations for correcting issues with sensitive data. For instance, in response to determining that a digital content item includes sensitive information with open access to the digital content item, the queue priority management system 102 can generate a recommendation to fix the access rights. Additionally, the queue priority management system can provide a recommendation to redact or otherwise obfuscate sensitive information in a digital content item with a high sensitivity level. The queue priority management system 102 can also automatically perform certain operations in connection with identifying sensitive information, such as automatically changing access rights to a digital content item upon detecting an issue with the digital content item.

Additionally, FIG. 11 illustrates that the client device displays a set of additional attributes to detect in scanned data. For instance, the additional attributes include a security setting attribute 1102. As an example, the additional attributes can include, but are not limited to, whether a scanned digital content item is locked or open, whether a digital content item is encrypted, a file size threshold of a digital content item, a creation date of a digital content item, etc. The queue priority management system 102 can utilize selected data attributes in connection with the selected framework 1100 to determine priority levels of digital content items. In some embodiments, the queue priority management system 102 can also provide tools for manually indicating specific classifications (e.g., via manually entered terms or phrases).

In some embodiments, the queue priority management system 102 provides tools for indicating a number of priority levels. Specifically, FIG. 11 illustrates that the client device displays a priority level slider 1104 that determines a total number of different priority levels for processing digital content items via priority-based processing queues. For example, the queue priority management system 102 utilizes the number of priority levels to determine a total number of priority-based processing queues to use in routing digital content items. Alternatively, the queue priority management system 102 can determine a number of priority levels based on the selected framework 1100 and/or information indicated with specific classifications of data.

In one or more embodiments, the queue priority management system 102 adds additional priority-based processing queues to a processing queue while processing a dataset. For instance, the queue priority management system 102 can generate a high priority processing and a low priority processing queue in response to determining priority levels of a first subset of digital content items. The queue priority management system 102 can generate an additional priority-based processing queue (e.g., a medium priority processing queue) in response to determining priority levels of a second subset of digital content items that include one or more digital content items of an additional priority level. Thus, the queue priority management system 102 can modify the processing queues in real-time as the queue priority management system processes additional data.

FIG. 11 also illustrates that the client device displays a save element 1106 to save the classification profile for use in one or more scanning requests. The queue priority management system 102 can save the classification profile for the entity to use in classifying digital content items according to the selected framework 1100 and the security setting attribute 1102. The queue priority management system 102 can modify the classification profile in response to additional inputs modifying the system requirements framework and/or additional attributes.

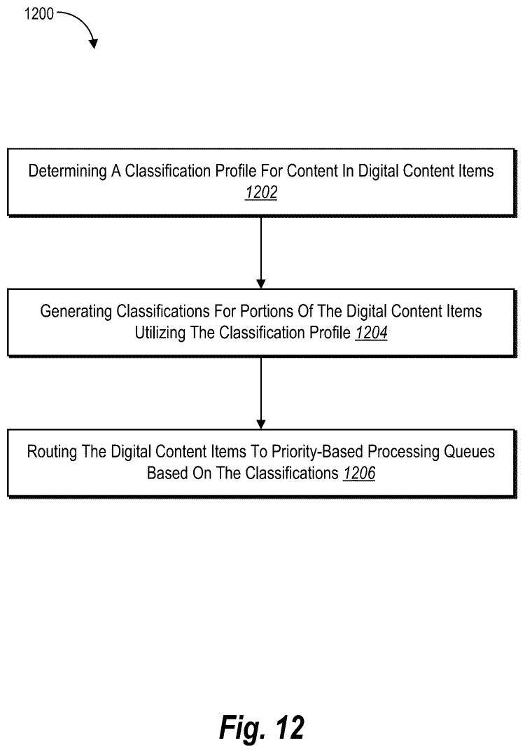

Turning now to FIG. 12, this figure shows a flowchart of a process 1200 of routing digital content items via priority-based processing queues according to data classifications. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer readable medium can comprise instructions, that when executed by one or more processors, cause a computing device to perform the acts of FIG. 12. In still further embodiments, a system can perform the acts of FIG. 12.

As shown, the process 1200 includes an act 1202 of determining a classification profile for content in digital content items. In some aspects, act 1202 is implemented using one or more examples described above with respect to FIGS. 4 and 7. The process 1200 also includes an act 1204 of generating classifications for portions of the digital content items utilizing the classification profile. In one or more aspects, act 1204 is implemented using one or more examples described above with respect to FIGS. 3, 4 and 7. Additionally, the process 1200 includes an act 1206 of routing the digital content items to priority-based processing queues based on the classifications. In one or more aspects, act 1206 is implemented using one or more examples described above with respect to FIGS. 2, 4, 5, and 7.

In one or more embodiments, the process 1200 includes determining a classification profile indicating priority levels for content in a plurality of digital content items at a digital data repository according to a system requirements framework. The process 1200 further includes generating, utilizing a classification model with the classification profile, classifications for portions of data extracted from the plurality of digital content items. The process 1200 also includes routing the plurality of digital content items via a plurality of priority-based processing queues based on the classifications generated for the portions of data of the plurality of digital content items.

The process 1200 can include determining the classification profile comprises determining a plurality of text terms or patterns of data that correspond to the system requirements framework. For example, the process 1200 can include determining a first set of text terms or patterns of data that correspond to the system requirements framework in response to input via a graphical user interface of a client device. The process 1200 can also include determining a second set of text terms or patterns of data that correspond to the system requirements framework based on relationships between the text terms or the patterns of data and the system requirements framework detected in historical data. For example, the process 1200 can include detecting the relationships between the text terms or the patterns of data and the system requirements framework by utilizing a machine-learning model to determine relationships between types of data in digital content items and controls associated with the system requirements framework. The process 1200 can also include generating mappings indicating the relationships between the text terms or the patterns of data and the system requirements framework.

The process 1200 can include parsing data from a digital content item of the plurality of digital content items to determine a first portion and a second portion of the digital content item. The process 1200 can further include generating a first classification for the first portion utilizing the classification model with the classification profile. The process 1200 can also include generating a second classification for the second portion utilizing the classification model with the classification profile.

Additionally, the process 1200 can include determining that the first classification of the first portion indicates a first priority level. The process 1200 can include determining that the second classification of the second portion indicates a second priority level. The process 1200 can also include routing the digital content item to a priority-based processing queue corresponding to the second priority level in response to the second priority level being higher than the first priority level.

The process 1200 can include routing a first digital content item of the plurality of digital content items to a first priority-based processing queue according to a first classification of data extracted from the first digital content item. The process 1200 can also include routing a second digital content item of the plurality of digital content items to a second priority-based processing queue according to a second classification of data extracted from the second digital content item.

The process 1200 can further include performing one or more computing operations on the first digital content item in the first priority-based processing queue prior to performing one or more additional computing operations on the second digital content item in the second priority-based processing queue in response to determining that the first priority-based processing queue has a first priority level higher than a second priority level of the second priority-based processing queue. The process 1200 can also include determining that the first priority-based processing queue comprising the first priority level is empty prior to accessing one or more digital content items in the second priority-based processing queue comprising the second priority level.

The process 1200 can include generating, for display via a graphical user interface of a client device, a plurality of notifications indicating priority levels of a subset of digital content items comprising one or more priority levels above a threshold priority level. The process 1200 can include providing, for display via the graphical user interface, a sample of data from a digital content item of the subset of digital content items classified to the one or more priority levels above the threshold priority level.

In one or more embodiments, the process 1200 includes determining a classification profile indicating priority levels for content in a plurality of digital content items at the digital data repository according to one or more system requirements frameworks. The process 1200 can also include generating, utilizing a classification model with the classification profile, data payloads for the plurality of digital content items comprising classifications for portions of data extracted from the plurality of digital content items according to the classification profile. Additionally, the process 1200 can include routing the plurality of digital content items to a plurality of priority-based processing queues based on the classifications generated for the portions of data of the plurality of digital content items. The process 1200 can also include providing, for display via a graphical user interface of a client device, indications of the classifications of the portions of data extracted from the plurality of digital content items utilizing the data payloads.

The process 1200 can also include determining a first set of text terms or patterns of data corresponding to a first priority level according to the one or more system requirements frameworks. Additionally, the process 1200 can include determining a second set of text terms or patterns of data corresponding to a second priority level according to the one or more system requirements frameworks, the first priority level being higher than the second priority level.

The process 1200 can further include generating a plurality of classifications for a plurality of portions of a digital content item of the plurality of digital content items utilizing the classification model with the classification profile. The process 1200 can also include generating, for the digital content item, a data payload comprising the plurality of classifications for the plurality of portions of the digital content item.

Additionally, the process 1200 can include determining, utilizing the classification model with the classification profile, that a portion of data extracted from a digital content item comprises a text term or a pattern of data that corresponds to a classification with a particular priority level according to the one or more system requirements frameworks. The process 1200 can also include generating a label for the portion of data extracted from the digital content item indicating the particular priority level within a data payload for the digital content item.

The process 1200 can further include determining a priority level of a digital content item based on a classification of at least one portion of data of the digital content item. The process 1200 can include routing the digital content item to a priority-based queue corresponding to the priority level of the digital content item.

The process 1200 can also include determining an additional priority level of an additional digital content item based on a classification of at least one portion of data of the additional digital content item. The process 1200 can include routing the additional digital content item to an additional priority-based queue corresponding to the additional priority level of the additional digital content item, the additional priority level of the additional digital content item being higher than the priority level of the digital content item.

Furthermore, the process 1200 can include determining, from a data payload corresponding to a digital content item, classifications of portions of data of the digital content item. The process 1200 can also include providing, for display via the graphical user interface of the client device, an indication of a classification comprising a highest priority level of the classifications of the portions of data of the digital content item.

Additionally, the process 1200 can include determining, based on the data payload corresponding to the digital content item, that the digital content item comprises a plurality of portions corresponding to the classification comprising the highest priority level. The process 1200 can further include providing, for display via the graphical user interface of the client device, an indication of a selected portion of the plurality of portions corresponding to the classification comprising the highest priority level.

According to one or more embodiments, the process 1200 includes determining a classification profile indicating priority levels for content in a plurality of digital content items at a digital data repository according to a system requirements framework. The process 1200 can include generating, utilizing a classification model with the classification profile, classifications for portions of data extracted from the plurality of digital content items. The process 1200 can further include routing a first digital content item of the plurality of digital content items to a first priority-based processing queue based on a first set of classifications of data extracted from the first digital content item. Additionally, the process 1200 can include routing a second digital content item of the plurality of digital content items to a second priority-based processing queue based on a second set of classifications of data extracted from the second digital content item, the first priority-based processing queue comprising higher priority content than the second priority-based processing queue.

The process 1200 can include generating, utilizing the classification model, the first set of classifications of data extracted from the first digital content item by comparing portions of the first digital content item to text terms or patterns of data in the classification profile. The process 1200 can include generating, utilizing the classification model, the second set of classifications of data extracted from the second digital content item by comparing portions of the second digital content item to the text terms or the patterns of data in the classification profile.

The process 1200 can include generating the first set of classifications of data extracted from the first digital content item by generating a first label indicating a data type for a portion of the first digital content item and a second label indicating a security attribute of the first digital content item. The process 1200 can further include routing the first digital content item to the first priority-based processing queue based on the first label and the second label.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. One will appreciate that one or more computing devices such as the computing device 1300 may implement the system(s) of FIG. 1. As shown by FIG. 13, the computing device 1300 can comprise a processor 1302, a memory 1304, a storage device 1306, an I/O interface 1308, and a communication interface 1310, which may be communicatively coupled by way of a communication infrastructure 1312. In certain embodiments, the computing device 1300 can include fewer or more components than those shown in FIG. 13. Components of the computing device 1300 shown in FIG. 13 will now be described in additional detail.

In one or more embodiments, the processor 1302 includes hardware for executing instructions, such as those making up a computer program. As an example, and not by way of limitation, to execute instructions for dynamically modifying workflows, the processor 1302 may retrieve (or fetch) the instructions from an internal register, an internal cache, the memory 1304, or the storage device 1306 and decode and execute them. The memory 1304 may be a volatile or non-volatile memory used for storing data, metadata, and programs for execution by the processor(s). The storage device 1306 includes storage, such as a hard disk, flash disk drive, or other digital storage device, for storing data or instructions for performing the methods described herein.

The I/O interface 1308 allows a user to provide input to, receive output from, and otherwise transfer data to and receive data from computing device 1300. The I/O interface 1308 may include a mouse, a keypad or a keyboard, a touch screen, a camera, an optical scanner, network interface, modem, other known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1308 is configured to provide graphical data to a display for presentation to a user. The graphical data may be representative of one or more graphical user interfaces and/or any other graphical content as may serve a particular implementation.

The communication interface 1310 can include hardware, software, or both. In any event, the communication interface 1310 can provide one or more interfaces for communication (such as, for example, packet-based communication) between the computing device 1300 and one or more other computing devices or networks. As an example, and not by way of limitation, the communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1310 may facilitate communications with various types of wired or wireless networks. The communication interface 1310 may also facilitate communications using various communication protocols. The communication infrastructure 1312 may also include hardware, software, or both that couples components of the computing device 1300 to each other. For example, the communication interface 1310 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, by at least one computer processor, a classification profile indicating priority levels for content in a plurality of digital content items at a digital data repository according to a system requirements framework;
generating, by the at least one computer processor utilizing a classification model with the classification profile, classifications for portions of data extracted from the plurality of digital content items; and
routing, by the at least one computer processor, the plurality of digital content items via a plurality of priority-based processing queues based on the classifications generated for the portions of data of the plurality of digital content items.

2. The computer-implemented method of claim 1, wherein determining the classification profile comprises determining a plurality of text terms or patterns of data that correspond to the system requirements framework.

3. The computer-implemented method of claim 2, wherein determining the classification profile comprises:
determining a first set of text terms or patterns of data that correspond to the system requirements framework in response to input via a graphical user interface of a client device; and
determining a second set of text terms or patterns of data that correspond to the system requirements framework based on relationships between the text terms or the patterns of data and the system requirements framework detected in historical data.

4. The computer-implemented method of claim 1, wherein generating the classifications for the portions of data extracted from the plurality of digital content items comprises:
parsing data from a digital content item of the plurality of digital content items to determine a first portion and a second portion of the digital content item;
generating a first classification for the first portion utilizing the classification model with the classification profile; and
generating a second classification for the second portion utilizing the classification model with the classification profile.

5. The computer-implemented method of claim 4, wherein routing the plurality of digital content items comprises:
determining that the first classification of the first portion indicates a first priority level;
determining that the second classification of the second portion indicates a second priority level; and
routing the digital content item to a priority-based processing queue corresponding to the second priority level in response to the second priority level being higher than the first priority level.

6. The computer-implemented method of claim 1, wherein routing the plurality of digital content items comprises:
routing a first digital content item of the plurality of digital content items to a first priority-based processing queue according to a first classification of data extracted from the first digital content item; and
routing a second digital content item of the plurality of digital content items to a second priority-based processing queue according to a second classification of data extracted from the second digital content item.

7. The computer-implemented method of claim 6, further comprising performing one or more computing operations on the first digital content item in the first priority-based processing queue prior to performing one or more additional computing operations on the second digital content item in the second priority-based processing queue in response to determining that the first priority-based processing queue has a first priority level higher than a second priority level of the second priority-based processing queue.

8. The computer-implemented method of claim 7, wherein performing the one or more computing operations on the second digital content item comprises determining that the first priority-based processing queue comprising the first priority level is empty prior to accessing one or more digital content items in the second priority-based processing queue comprising the second priority level.

9. The computer-implemented method of claim 1, further comprising:
generating, for display via a graphical user interface of a client device, a plurality of notifications indicating priority levels of a subset of digital content items comprising one or more priority levels above a threshold priority level; and
providing, for display via the graphical user interface, a sample of data from a digital content item of the subset of digital content items classified to the one or more priority levels above the threshold priority level.

10. A system comprising:
one or more non-transitory computer readable media having access to a digital data repository; and
at least one computer processor configured to cause the system to:
determine a classification profile indicating priority levels for content in a plurality of digital content items at the digital data repository according to one or more system requirements frameworks;
generate, utilizing a classification model with the classification profile, data payloads for the plurality of digital content items comprising classifications for portions of data extracted from the plurality of digital content items according to the classification profile;
route the plurality of digital content items to a plurality of priority-based processing queues based on the classifications generated for the portions of data of the plurality of digital content items; and
provide, for display via a graphical user interface of a client device, indications of the classifications of the portions of data extracted from the plurality of digital content items utilizing the data payloads.

11. The system of claim 10, wherein the at least one computer processor is further configured to cause the system to determine the classification profile by:
determining a first set of text terms or patterns of data corresponding to a first priority level according to the one or more system requirements frameworks; and
determining a second set of text terms or patterns of data corresponding to a second priority level according to the one or more system requirements frameworks, the first priority level being higher than the second priority level.

12. The system of claim 10, wherein the at least one computer processor is further configured to cause the system to generate the data payloads for the plurality of digital content items by:
generating a plurality of classifications for a plurality of portions of a digital content item of the plurality of digital content items utilizing the classification model with the classification profile; and
generating, for the digital content item, a data payload comprising the plurality of classifications for the plurality of portions of the digital content item.

13. The system of claim 10, wherein the at least one computer processor is further configured to cause the system to generate the data payloads for the plurality of digital content items by:
determining, utilizing the classification model with the classification profile, that a portion of data extracted from a digital content item comprises a text term or a pattern of data that corresponds to a classification with a particular priority level according to the one or more system requirements frameworks; and
generating a label for the portion of data extracted from the digital content item indicating the particular priority level within a data payload for the digital content item.

14. The system of claim 10, wherein the at least one computer processor is further configured to cause the system to route the plurality of digital content items to the plurality of priority-based processing queues by:
determining a priority level of a digital content item based on a classification of at least one portion of data of the digital content item; and
routing the digital content item to a priority-based queue corresponding to the priority level of the digital content item.

15. The system of claim 14, wherein the at least one computer processor is further configured to cause the system to route the plurality of digital content items to the plurality of priority-based processing queues by:
determining an additional priority level of an additional digital content item based on a classification of at least one portion of data of the additional digital content item; and
routing the additional digital content item to an additional priority-based queue corresponding to the additional priority level of the additional digital content item, the additional priority level of the additional digital content item being higher than the priority level of the digital content item.

16. The system of claim 10, wherein the at least one computer processor is further configured to cause the system to provide the indications of the classifications of the portions of data extracted from the plurality of digital content items utilizing the data payloads by:
determining, from a data payload corresponding to a digital content item, classifications of portions of data of the digital content item; and
providing, for display via the graphical user interface of the client device, an indication of a classification comprising a highest priority level of the classifications of the portions of data of the digital content item.

17. The system of claim 16, wherein the at least one computer processor is further configured to cause the system to provide the indications of the classifications of the portions of data extracted from the plurality of digital content items utilizing the data payloads by:
determining, based on the data payload corresponding to the digital content item, that the digital content item comprises a plurality of portions corresponding to the classification comprising the highest priority level; and
providing, for display via the graphical user interface of the client device, an indication of a selected portion of the plurality of portions corresponding to the classification comprising the highest priority level.

18. A non-transitory computer readable medium comprising instructions that, when executed by at least one computer processor, cause the at least one computer processor to:
determine a classification profile indicating priority levels for content in a plurality of digital content items at a digital data repository according to a system requirements framework;
generate, utilizing a classification model with the classification profile, classifications for portions of data extracted from the plurality of digital content items;
route a first digital content item of the plurality of digital content items to a first priority-based processing queue based on a first set of classifications of data extracted from the first digital content item; and
route a second digital content item of the plurality of digital content items to a second priority-based processing queue based on a second set of classifications of data extracted from the second digital content item, the first priority-based processing queue comprising higher priority content than the second priority-based processing queue.

19. The non-transitory computer readable medium of claim 18, further comprising instructions that, when executed by the at least one computer processor, cause the at least one computer processor to generate the classifications for the portions of data extracted from the plurality of digital content items by:
generating, utilizing the classification model, the first set of classifications of data extracted from the first digital content item by comparing portions of the first digital content item to text terms or patterns of data in the classification profile; and
generating, utilizing the classification model, the second set of classifications of data extracted from the second digital content item by comparing portions of the second digital content item to the text terms or the patterns of data in the classification profile.

20. The non-transitory computer readable medium of claim 18, further comprising instructions that, when executed by the at least one computer processor, cause the at least one computer processor to:
generate the first set of classifications of data extracted from the first digital content item by generating a first label indicating a data type for a portion of the first digital content item and a second label indicating a security attribute of the first digital content item; and
route the first digital content item to the first priority-based processing queue based on the first label and the second label.
